(19) United States
(12) Patent Application Publication
(10) Pub. No.: US 2016/0350851 A1
(43) Pub. Date: Dec. 1, 2016

(54) CLIENTELING CREDIT SUGGESTION CONFIDENCE

(71) Applicant: Comenity LLC, Columbus, OH (US)

(72) Inventors: Richard Barber AINSWORTH, III, Dublin, OH (US); Todd ARMSTRONG, Shelby, NC (US); Joseph HASH, Lewis Center, OH (US); Joshua SNYDER-HILL, Columbus, OH (US)

(73) Assignee: Comenity LLC, Columbus, OH (US)

(21) Appl. No.: 15/164,740

(22) Filed: May 25, 2016

Related U.S. Application Data
(60) Provisional application No. 62/166,481, filed on May 26, 2015.

(51) Int. Cl. G06Q 40/02

(52) U.S. Cl. CPC G06Q 40/025

(57) ABSTRACT

A method for providing clienteling credit suggestion confidence is disclosed. The method comprises obtaining identification information about a client. Next, the present method then utilizes the identification information to prescreen the client for a store credit offer. Then, the present method provides a confidential signal indicating the result of the prescreen.

### CROSS-REFERENCE TO RELATED APPLICATIONS (PROVISIONAL)

This application claims priority to and benefit of co-pending U.S. Provisional Patent Application No. 62/166,481 filed on May 26, 2015, entitled “CLIENTELING CREDIT SUGGESTION CONFIDENCE” by Ainsworth, III et al., and assigned to the assignee of the present application, the disclosure of which is hereby incorporated herein by reference in its entirety.

### BACKGROUND

Company specific, brand specific or even store specific credit cards provide significant value to both consumer and provider. By issuing a store specific credit card, the provider is able to tailor rewards offers, provide loyalty discounts and maintain consumer brand loyalty. Similarly, the consumer receives the perks from the reward offers, the loyalty discounts and often provides good word provider recommendations via word of mouth, social networks, internet rating sites, and the like.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a clienteling credit suggestion confidence system, in accordance with an embodiment.

FIG. 2 depicts a flow diagram for a method for clienteling credit suggestion confidence, in accordance with an embodiment.

FIG. 3 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended Claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “correlating”, “prescreening”, “developing”, “presenting” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview

In the following discussion, clienteling refers to a relationship between a customer referred to hereinafter as a “client”, and a sales associate. Moreover, clienteling may occur at the register or be distributed to associates on the sales floor. For example, a client spends a certain amount while shopping at a certain store. The client returns to the store at a different time and again spends a minimum amount. The managements will assign an associate to build a client type relationship with the client. The relationship will include the associate getting to know the client. For example, the associate would learn information such as, but not limited to the clients: identification information, clothing size, style, taste, likes, dislikes, family members, address, and important dates, such as anniversaries, birthdays, and the like. The associate will then utilize the information about the client to tailor the clients shopping experiences.

For example, the client may contact the associate with a request for an outfit for an upcoming event. The client can describe the event and then the associate could select the appropriate clothes, have the clothes tailored and then have the clothes delivered to the client. In another embodiment, the associate notices that the client's wife's birthday is approaching. The associate could contact the client and let him know about a new product, or a product that the matches the client's wife's taste. The growing relationship between the associate and the client is clienteling.

However, in the clienteling relationship, associates may be hesitant to offer store brand credit to their clients for fear of a rejection or a credit limit well below the client's spending desire. As such, the associate will not promote or even suggest the client apply for the store brand credit and instead rely on the client's existing credit cards. By integrating a credit prescreen, based on the previously provided client information, to deliver an indication of the client's likelihood of being approved and an approximation of the credit line amount would enable store associates to more confidently invite their client to apply for store brand credit.

In the following discussion, the term “prescreen” is utilized. In general, prescreen refers to a credit prescreen for a client. That is, a screening of a client based on some sort of identification information that allows a likely credit determination to be performed. For example, if Joe Bloggs is pre-screened, identifying information would be obtained, such as, his address. The name and address would be used to perform a quick and dirty check of at least a portion of Joe Bloggs credit history. The search may be a credit score, a search of outstanding debts, home ownership, other credit cards, and the like. In other words, the prescreen is much less formal than an actual credit check.

Moreover, depending on present or future credit prescreening requirements, rules and regulations, the credit prescreen described herein may be even less formal than that associated with a credit score review. For example, if the legislation requires a customer be informed, or provide authorization, before a review of the client's credit score, the credit prescreen described herein may be based on a different metric such as home ownership, collections records, job history, etc. Thus, the credit prescreen is not intended to be limited to only a prescreen that will result in certain approval. Instead, in one embodiment, the credit prescreen described herein, is an informal prescreen attempting to increase the success rates for client's being offered the credit. Thus, although a client may pass the credit prescreen discussed herein, because of its possible informal nature, the client may still not pass the actual application process due to a credit issue in the formal application process. However, the informal credit screen will be valuable in identifying clients that will likely pass and also clients that will not likely pass. In the case of the likely pass clients, an offer to apply can be made. In contrast, in the case of the not likely pass clients, that client will not be solicited with the offer to apply.

### Operation

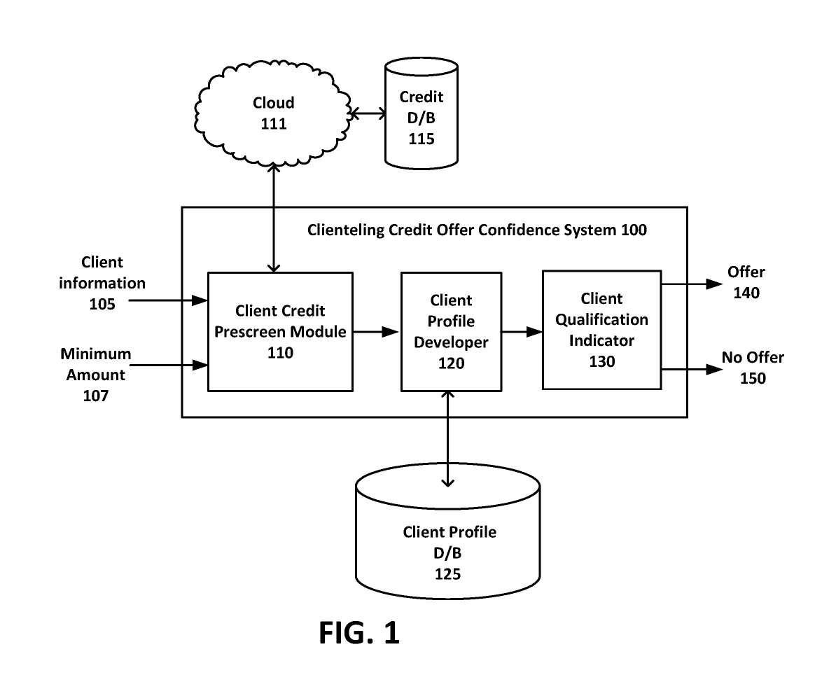

FIG. 1 is a block diagram of a clienteling credit suggestion confidence system 100 shown in accordance with an embodiment. In an embodiment, clienteling credit suggestion confidence system 100 includes client credit prescreen module 110, client profile developer 120 and client qualification indicator 130. Clienteling credit suggestion confidence system 100 receives client information 105 which may be selected from the group including, but not limited to, identification information, family members, address, purchase history and the like.

In one embodiment, clienteling credit suggestion confidence system 100 receives client information 105 at client credit prescreen module 110. Client credit prescreen module 110 accesses a credit database 115 via cloud 111 to determine credit information for a client based on the client information 105. An example of cloud 111 is a network such as the Internet or the like.

Client credit prescreen module 110 will then analyze the client credit information found in credit database 115 to determine if the client passes a prescreen offer level. In one embodiment, client credit prescreen module 110 will also receive a minimum amount 107. In general, minimum amount 107 refers to a minimum credit limit for the client to prequalify. For example, the minimum amount 107 may be 5,000.00 USD. In the case where client credit prescreen module 110 receives minimum amount 107, client credit prescreen module 110 will utilize the client credit information found in credit database 115 in conjunction with the minimum amount 107 requirement to determine if the client is reasonably likely to receive an acceptable credit line if approved upon application for credit.

Client credit prescreen module 110 provides the resultant prescreen information to client profile developer 120. Client profile developer 120 utilizes client information 105 and the results of the prescreen to develop a client profile. Once a client profile is developed, the client profile is stored in client profile database 125. In an embodiment, the client profile may be updated by an associate or by the client. For example, the associate or the client may add profile information such as, but not limited to, identification information, clothing size, style, taste, likes, dislikes, family members, address, important dates, purchase history and the like. In another embodiment, the client profile update capabilities are established and modifiable based on the present legal regulations and requirements.

Client qualification indicator 130 will receive the prequalification prescreen results from client profile developer 120 and provide a confidential indication of the result of the prescreen. For example, if the client qualifies based on the prescreen, client qualification indicator 130 will provide a confidential signal that will let the associate know that a suggestion should be given to the client to apply for store credit. In an embodiment, if the client does not pass the store credic qualification prescreen, client qualification indicator 130 will provide a confidential signal that will let the associate know that a suggestion to apply for credit should not be made to the client. By providing the associate with the confidential credit prescreen results, when the store associate notes that the prescreen results in a suggestion to apply 140, the associate is able to confidently invite the client to apply for the store brand credit.

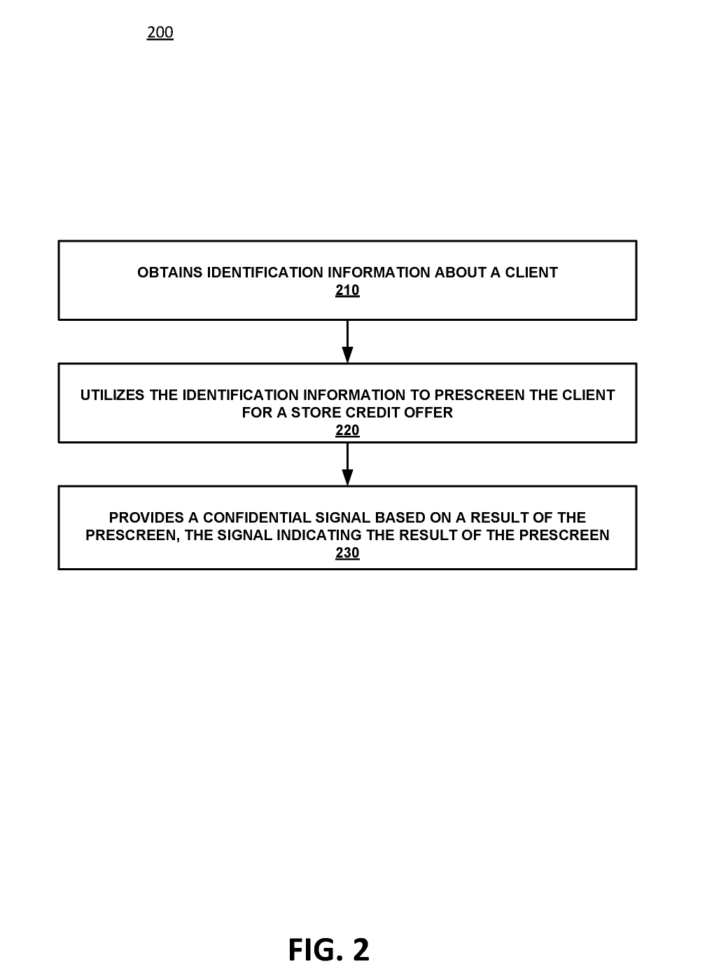

FIG. 2 depicts a flow diagram for a method for clienteling credit suggestion confidence, in accordance with an embodiment. In other words, by prescreening the client and receiving a positive indication, the associate will be confident to suggest that the client apply for store credit while reducing the concern about embarrassing the client due to denial. Thus, by providing an unobtrusive prescreen, the store can minimize the occurrence of an associate suggestion that a client apply for store credit, having the client agree to apply for the store credit, and then determining the client doesn't qualify for the store credit.

With reference now to 210 of FIG. 2 and FIG. 1, one embodiment obtains identification information about a client. In general, client information 105 includes enough information to enable a credit prescreening. For example, prescreening occurs when an associate inputs identifying information about the client into the clienteling credit suggestion confidence system 100.

In one embodiment, client information 105 may be a name and address, driver's license number, social security number, or other unique identifier. Moreover, the information may be obtained from the client or via the client. For example, client information 105 is obtained from the client by a sales associate during the clienteling process when the client asks for specific information.

In another embodiment, information obtained via the client refers to the client initiating the providing of client information 105 to the associate. In one embodiment, a client may use a mobile smart device to provide client information 105. Examples of a mobile smart device include, but are not limited to, a mobile phone, tablet, smart glasses, smart watch, and the like. In general, the information may be provided via wireless connectivity such as 3G, 4G, WiFi, Bluetooth, and the like. In one embodiment, the client may scan a barcode on a poster, or the like. For example, the barcode scan will direct the client's mobile device to an identification site, where a client can provide the client information 105, without applying for any type of store credit card.

Referring now to 220 of FIG. 2 and FIG. 1, one embodiment utilizes the identification information to prescreen the client for a store credit offer. For example, client information 105 is entered via an associate's mobile device or the like into clienteling credit suggestion confidence system 100. Client information 105 is then used by client credit prescreen module 110 to access credit database 115 and determine is the client qualifies for store credit. In one embodiment, in addition to client information 105, client credit prescreen module 110 also receives a minimum store credit offer amount for the client and prescreens the client based on the minimum store credit offer amount.

With reference now to 230 of FIG. 2 and FIG. 1, one embodiment provides a confidential signal based on a result of the prescreen, the signal indicating the result of the prescreen. For example, client qualification indicator 130 provides a positive signal to the associate, the positive signal informing the associate that there is a reasonable chance that the client would be approved for credit and therefore should receive offer 140. In another embodiment, client qualification indicator 130 provides a negative signal to the associate, the negative signal informing the associate that there is not enough of a chance, per the ADS standard underwriting guidelines, that the client may be approved for credit and therefore should not be presented with the opportunity to apply for credit 150. In one embodiment, the store credit offer is presented to the client. In another embodiment, the associate may receive a bonus when the store credit offer is accepted.

For example, during the clienteling process the associate asks the client's name and address to sign the client up to a loyalty program with an instant 10% off of any purchases made that day. The client provides the associate with client information 105. Client information 105 is then entered into the clienteling credit suggestion confidence system 100, such as by the associate via a mobile device or the like. Clienteling credit suggestion confidence system 100 will prescreen the client to determine if the client meets the criteria for store credit. One criterion would be a client credit score. Additional criterion may include, but is not limited to, a client's membership in another reward program, a client's purchase history and the like.

In one embodiment, the associate receives the confidential results of the prescreening. In one embodiment, the results may be shown at the point of sale, via a text message to the associate's mobile smart device, or the like. For example, the successful results may be as simple as “suggest client apply for store credit card”, a green light, check mark next to the clients name or the like. In another embodiment, unsuccessful results may be a statement such as “don't suggest client apply for store credit card”, a red light, x next to the clients name or the like. In so doing, the associate reduces the possibility for an uncomfortable exchange with a client wherein the client is asked to apply for a store credit card and then informed that they did not qualify.

In one embodiment, the client information 105 and the results from the prescreen are utilized by client profile developer 120 to develop a client profile. In one embodiment, the client profile is stored in a client profile database 125. In one embodiment, the client profile may be updated with information such as, but not limited to, information received from the associate, a purchase history of the client, information received from the client and the like. For example, the client profile may include client input information such as anniversary dates, graduation dates, moving information, room remodel, hobbies, children's interests, spouse's interests and the like.

In one embodiment, the client profile is used to develop relevant offers to the client. The relevant offers may include, but are not limited to, new items for sale, items for date specific events, items that fit the client's needs, items that fit the client's purchase behavior, items on sale and the like.

By utilizing the clienteling credit suggestion confidence system 100, a store is able to shift from a black book or associate's personal client list to an e-based approach. In so doing, the store is able to maintain the upkeep of the client when the associate is not available, such as, if the associate is sick, promoted, moves to a different job, retires, or the like.

In addition, since the information is used by the client profile developer 120 to develop a client profile, contact to the client can be automatically monitored. For example, if the client's wife's birthday is approaching, client profile developer 120 will provide a reminder to the associate. The associate can then contact the client with an offer or sales opportunity that is both timely and appropriate in taste and style.

In another example, the store may receive a new item for sale. Client profile developer 120 would be able to search client profile database and select all clients with profiles that relate to the new item. The clienteling credit suggestion confidence system 100 would then contact the associate and alert them that the client that should be contacted about the new item for sale. In one embodiment, the contact to the associate from the clienteling credit suggestion confidence system 100 may be an email, text message, SMS or the like. In general, the same action may be taken for items for date specific events, items that fit the client's needs, items that fit the client's purchase behavior, items on sale, items that need to be sold, and the like.

For example, the client purchases a new couch. The client takes a photo of the new couch and provides the photo of the couch in conjunction with a decoration query to client profile developer 120. Client profile developer 120 will update the client profile to include the new couch and then pass the decoration query and couch photo to the clienteling associate. The associate would then be able to pick out designs, pillows, throws, and the like for the client. In one embodiment, the associate will provide the items to the client for review. For example, the associate may email images of the items to the client. In another embodiment, the associate will select and send the decorative items to the client and charge the client's account, such that the client will review the items when they are received. In yet another embodiment, the associate will set up an appointment to meet with the client and have the selected items laid out for the client's approval.

Example Computer System Environment

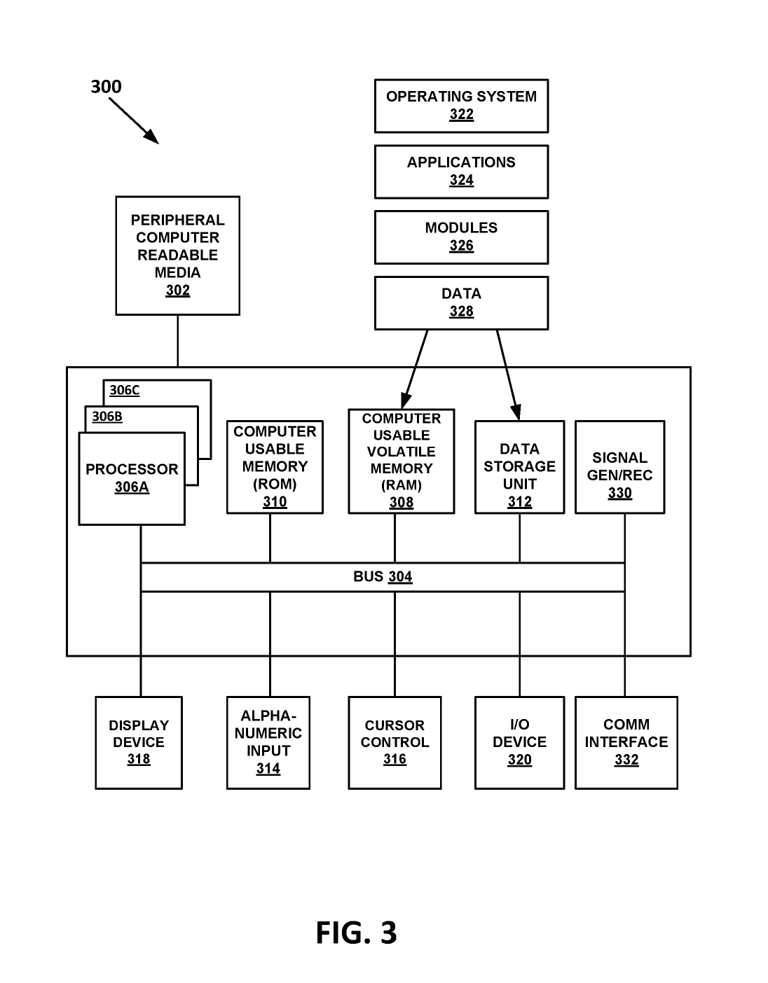

With reference now to FIG. 3, portions of the technology for providing a communication composed of computer-readable and computer-executable instructions that reside, for example, in non-transitory computer-usable storage media of a computer system. That is, FIG. 3 illustrates one example of a type of computer that can be used to implement embodiments of the present technology. FIG. 3 represents a system or components that may be used in conjunction with aspects of the present technology. In one embodiment, some or all of the components described herein may be combined with some or all of the components of FIG. 3 to practice the present technology.

FIG. 3 illustrates an example computer system 300 used in accordance with embodiments of the present technology. It is appreciated that system 300 of FIG. 3 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 3, computer system 300 of FIG. 3 is well adapted to having peripheral computer readable media 302 such as, for example, a floppy disk, a compact disc, a flash drive, and the like coupled thereto.

Computer system 300 of FIG. 3 includes an address/data/control bus 304 for communicating information, and a processor 306A coupled to bus 304 for processing information and instructions. As depicted in FIG. 3, system 300 is also well suited to a multi-processor environment in which a plurality of processors 306A, 306B, and 306C are present. Conversely, system 300 is also well suited to having a single processor such as, for example, processor 306A. Processors 306A, 306B, and 306C may be any of various types of microprocessors. Computer system 300 also includes data storage features such as a computer usable volatile memory 308, e.g., random access memory (RAM), coupled to bus 304 for storing information and instructions for processors 306A, 306B, and 306C.

System 300 also includes computer usable non-volatile memory 310, e.g., read only memory (ROM), coupled to bus 304 for storing static information and instructions for processors 306A, 306B, and 306C. Also present in system 300 is a data storage unit 312 (e.g., a magnetic disk drive, optical disk drive, solid state drive (SSD), and the like) coupled to bus 304 for storing information and instructions. Computer system 300 also includes an optional alpha-numeric input device 314 including alphanumeric and function keys coupled to bus 304 for communicating information and command selections to processor 306A or processors 306A, 306B, and 306C. Computer system 300 also includes an optional cursor control device 316 coupled to bus 304 for communicating user input information and command selections to processor 306A or processors 306A, 306B, and 306C. Optional cursor control device may be a touch sensor, gesture recognition device, and the like. Computer system 300 of the present embodiment also includes an optional display device 318 coupled to bus 304 for displaying information.

Referring still to FIG. 3, optional display device 318 of FIG. 3 may be a liquid crystal device, cathode ray tube, OLED, plasma display device or other display device suitable for creating graphic images and alpha-numeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick, non-contact input, gesture recognition, voice commands, bio recognition, and the like. In addition, special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. Computer system 300 also includes an I/O device 320 for coupling system 300 with external entities. For example, in one embodiment, I/O device 320 is a modem for enabling wired or wireless communications between system 300 and an external network such as, but not limited to, the Internet or intranet. A more detailed discussion of the present technology is found below.

Referring still to FIG. 3, various other components are depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312. The present technology may be applied to one or more elements of described system 300.

System 300 also includes one or more signal generating and receiving device(s) 330 coupled with bus 304 for enabling system 300 to interface with other electronic devices and computer systems. Signal generating and receiving device(s) 330 of the present embodiment may include wired serial adaptors, modems, and network adaptors, wireless modems, and wireless network adaptors, and other such communication technology. The signal generating and receiving device(s) 330 may work in conjunction with one or more communication interface(s) 332 for coupling information to and/or from system 300. Communication interface 332 may include a serial port, parallel port, Universal Serial Bus (USB), Ethernet port, Bluetooth, thunderbolt, near field communications port, WiFi, Cellular modem, or other input/output interface. Communication interface 332 may physically, electrically, optically, or wirelessly (e.g., via radio frequency) couple system 300 with another device, such as a mobile telephone, radio, or computer system.

The computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the Claims is not necessarily limited to the specific features or acts described above. Rather, the specific features and acts described above are disclosed by way of illustration and as example forms of implementing the concepts and their equivalents.

We claim:

1. A non-transitory computer-readable storage medium having instructions embodied therein that when executed cause a computer system to perform a method for clienteling credit suggestion confidence, the method comprising:
obtaining identification information about a client;
utilizing the identification information to prescreen the client for a store credit offer; and
providing a confidential signal based on a result of the prescreen, the signal indicating the result of the prescreen.

2. The non-transitory computer-readable storage medium of claim 1, further comprising:
providing a positive signal to an associate, the positive signal informing the associate that the client has passed the prescreen.

3. The non-transitory computer-readable storage medium of claim 1, further comprising:
providing a negative signal to an associate, the negative signal informing the associate that the client has not passed the prescreen.

4. The non-transitory computer-readable storage medium of claim 1, further comprising:
receiving a minimum store credit offer amount for the client; and
prescreening the client based on the minimum store credit offer amount.

5. The non-transitory computer-readable storage medium of claim 1, further comprising: presenting the store credit offer to the client.

6. The non-transitory computer-readable storage medium of claim 5, further comprising:
providing a bonus to an associate when the store credit offer is accepted.

7. The non-transitory computer-readable storage medium of claim 1, further comprising:
utilizing the identification information about the client to create a client profile;
updating the client profile with information received from an associate;
updating the client profile with a purchase history of the client; and
updating the client profile with information received from the client.

8. The non-transitory computer-readable storage medium of claim 7, further comprising:
utilizing the client profile to develop relevant offers to the client from a group of offers consisting of: new items for sale, items for date specific events, items that fit a client's needs, items that fit a client's purchase behavior and items on sale.

9. A clienteling credit suggestion confidence system comprising:
a client credit prescreen module to receive information about a client and utilize the information to perform a store credit qualification prescreen;
a client profile developer to create and update a client profile based on received information about the client; and
a client credit prescreen indicator to provide a confidential indication of a result of the store credit qualification prescreen.

10. The system of claim 9 wherein a positive indication informs an associate that the client has passed the store credit qualification prescreen.

11. The system of claim 9 wherein a negative indication informs an associate that the client has not passed the store credit qualification prescreen.

12. The system of claim 9 wherein the client credit prescreen module receives a minimum credit limit for a client and utilize performs the store credit qualification prescreen based on the minimum credit limit.

13. The system of claim 9 wherein the received information about the client is selected from the group consisting of: identification information, clothing size, style, taste, likes, dislikes, family members, address, important dates and purchase history.

14. The system of claim 9 wherein the client profile is stored in a client profile database.

15. The system of claim 9 wherein the client profile is updated with information received from the client.

16. A computer-implemented method for clienteling credit suggestion confidence, the method comprising:
obtaining identification information about a client;
utilizing the identification information about the client to create a client profile;
utilizing the client profile to prescreen the client for a store credit offer;
providing a confidential signal based on a result of the prescreen, the signal indicating the result of the prescreen; and
presenting the store credit offer to the client if the client is approved.

17. The computer-implemented method as recited in claim 16, further comprising:
providing a positive signal to an associate, the positive signal informing the associate that the client is approved.

18. The computer-implemented method of claim 16, further comprising:
providing a negative signal to an associate, the negative signal informing the associate that the client is not approved.

19. The computer-implemented method as recited in claim 16, further comprising:
receiving a minimum store credit offer amount for the client; and
prescreening the client based on the minimum store credit offer amount.

20. The computer-implemented method as recited in claim 16, further comprising:
updating the client profile with information received from an associate;
updating the client profile with a purchase history of the client; and
updating the client profile with information received from the client.

21. The computer-implemented method as recited in claim 16, further comprising:
utilizing the client profile to develop relevant offers to the client from a group of offers consisting of: new items for sale, items for date specific events, items that fit a client's needs, items that fit a client's purchase behavior and items on sale.
